(19) United States
(12) Patent Application Publication
(10) Pub. No.: US 2015/0304220 A1
(43) Pub. Date: Oct. 22, 2015

(54) CONGESTION CONTROL SYSTEM, CONTROL DEVICE, CONGESTION CONTROL METHOD AND PROGRAM

(71) Applicant: NEC CORPORATION, Tokyo (JP)

(72) Inventor: Yasuhiro MIYAO, Tokyo (JP)

(21) Appl. No.: 14/646,369

(22) PCT Filed: Nov. 21, 2013
(86) PCT No.: PCT/JP2013/081440

§ 371 Date: May 20, 2015

(30) Foreign Application Priority Data
Nov. 22, 2012 (JP) 2012-256358

(51) Int. Cl. H04L 12/801; H04L 12/851

(52) U.S. Cl. CPC H04L 47/12; H04L 47/24

(57) ABSTRACT

A congestion control system includes: edge devices that aggregate service request messages from clients, and distribute the messages to servers; a plurality of servers that process the service requests from the clients; and a control device. The control device: acquires a service request occurrence rate observed from the edge devices, and, on the basis of the acquired occurrence rate, determines the proportion of service request messages to be regulated as a regulation rate; determines the number of servers that should be operating, and notifies the edge devices of the regulation rate that was determined; and, on the basis of the number of servers that was determined, puts new servers into operation or stops the service of currently operating servers. In a system in which there a limit to server expansion and there is potential for congestion collapse to occur, integrated control is conducted in such a manner that revenue, which allows for input regulation in edge devices and server expansion, is maximized.

### CROSS-REFERENCE TO RELATED APPLICATIONS

The present invention is based upon Japanese Patent Application No. 2012-256358, filed on Nov. 22, 2012, the entire contents of which are incorporated herein by reference.

The present invention relates to a congestion control system, a controller, and a congestion control method and program and, in particular, to a congestion control system, a controller, and a congestion control method and program relating to a plurality of geographically distributed servers.

### TECHNICAL FIELD

### Background Art

<Congestion and Congestion Control>

Congestion refers to a state in which traffic of processing requests exceeds the maximum processing capacity of a system and traffic effectively served decreases below the maximum processing capacity of the system. Such congestion occurs because part of the processing capacity of the system needs to be assigned to requests for which processing that cannot be completed. Congestion control in a specific system will be described below.

<Congestion Control in Communication Network>

In a fixed-phone network, congestion collapse comes to occur in a control system when incoming calls concentrate on a disaster-affected area and it becomes difficult to make connections, as described in NPL 1. In occurrence rate of a service order to prevent such congestion, a controller is constantly monitoring the status of switches at receiving ends on a typical telephone switching network as described in NPL 1. When the controller detects congestion, the controller issues a regulation instruction to switches at call originating ends.

NPL 2 discloses a 3GPP (3rd Generation Partnership Project) data communication network. When there are a plurality of eNodeB stations which terminate user terminals with a radio link and allocate the user terminals to a core network, and a plurality of MMEs (Mobility Management Entities) which are devices dealing with calls in the data communication network, the eNodeB stations and MMEs can be flexibly interconnected. In this connection mode, an MME is selected on the basis of relative capacities indicated from the MMEs. As a result, load balancing can be achieved among the plurality of MMEs. Furthermore, the MMEs can select connected radio termination aggregation device eNodeB stations at random to notify them of an overload state together with the rate of regulation.

NPL 3 states that a SIP server, which is collectively called CSCF (Call Session Control Function), is used for dealing with VOIP call in an IMS (IP Multimedia Subsystem). In this case, an Interrogating-CSCF (I-CSCF) is located at an entry point to a network and selects a Serving—CSCF (S-CSCF) that ultimately deals with calls for users.

A method for congestion control at a SIP server is described in NPL 4. In this method, when a SIP server detects congestion, the SIP server sends a congestion notification to an upstream node, where input regulation is performed. Such regulation on external inputs is internal control which returns an error response to a call service request that cannot be served by a typical SIP server and is a measure to inability to fundamentally solve congestion collapse.

Specific methods for input regulation includes percentage discard which discards a certain percentage of service requests sent to a server and a rate control which regulates the maximum number of service requests that can be sent in a given period of time.

### <Capacity Planning in Server Virtualization>

As described in NPL 5, in server virtualization which enables computer resources to be quickly set, a controller calculates the number of servers required on the basis of a result of monitoring the performance of servers and allows new servers to be added. This is also called capacity planning.

A management device in NPL 6 performs provisioning of physical servers and is also capable of providing information about servers to which calls can be redirected to a load balancer. Furthermore, the management device includes a mechanism that, immediately before a particular server enters an abnormal or faulty state, provides an instruction to reduce or stop traffic to the server to the load balancer.

<Load Balancing Among Servers by Taking Network-Level Delays into Consideration>

NPL 8 describes load balancing from one load balancer or client to a plurality of servers. In addition to processing delay at a server, the total delay including network-level processing delays is measured and the reciprocal of the total delay is used as a proportionality factor for the volume of traffic to be distributed among the servers.

### CITATION LIST

### Non Patent Literature

NPL 1: K. Mase and H. Yamamoto, “Advanced Traffic Control Methods for Network Management, “IEEE Communication Magazine, pp. 82-88, October 1990.
NPL 2: 3GPP TS23.401 V11.1.0 (2012-March)
NPL 3: TS23.228 V11.4.0 (2012-March) 3GPP Technical Specification Group Services and System Aspects; IP Multimedia Subsystem (IMS); Stage 2 (Release 11)
NPL 4: IETF RFC6357 V. Hilt, E. Noel, C. Shen, and A. Abdelal, “Design consideration for Session Initiation Protocol (SIP) overload control”
NPL 5: VMware vCenter Operations (2011)
NPL 6: F5 iControl White paper (2009)
NPL 7: R. R. Pillai, “A distributed overload control algorithm for delay-bounded call setup, “IEEEACM ToN, Vol. 9, No. 6, December 2001, pp. 780-789.
NPL 8: A. Karakos, D. Patsas, A. Bornea, and S. Kontogiannis, “Balancing HTTP traffic using dynamically updated weights, an implementation approach, “the 10th Panhellenic Conference on Informatics, 2005, pp. 873-878.

### SUMMARY OF INVENTION

### Technical Problem

Note that the entire contents disclosed in the non patent literatures cited above are incorporated herein by reference. The following analysis is given from the point of view of the present invention.

In a typical fixed-phone network, a control system and a speech path system are integrated into one system at switches making up the network and the processing capacity of the control system cannot easily be increased. Accordingly, congestion is avoided only by regulating inputs in an overload state.

In LTE (Long Term Evolution) of 3GPP, in particular in a mobile core, nodes that belong to a control system and nodes that belong to a user-data system are separated from MMEs and S-gateways and an eNodeB station can be connected to a plurality of MMEs. As operation relating to congestion control in such a configuration, the eNodeB station receives a notification of the processing capacity or congestion from each connected individual MME. However, concrete methods as to the timing of regulating inputs and what kinds of input regulation values are used to regulate inputs on the basis of the notifications are not specified.

In IMSSIP, a control system and a user system are separated from each other and a SIP (Session Initiation Protocol) server is responsible for the control system. The IETF (Internet Engineering Task Force) and other groups discuss a method in which a preceding SIP server externally addresses congestion collapse in addition to a method in which the SIP server itself internally addresses congestion collapse.

However, devices that are responsible for the control system are separated from the user data system in the LTE and the IMSSIP as stated above, which makes it potentially possible to flexibly increase or decrease their resources. Nevertheless, there is no known congestion control methods for combining this potential with the input regulation control described above to further increase traffic that can be accommodated.

On the other hand, controllers that manage capacities of physical servers and virtual servers in IT services basically only increase or decrease the number of servers and indicate available servers to a load balancer.

Furthermore, since load balancers have been provided from venders different from venders of server devices, the load balancers perform only allocations of messages to available servers. Against the same backdrop, servers can respond to processing requests message that cannot normally be served with an error to carry out local regulation. However, carrying out the local regulation itself wastes resources and, when the load increases, congestion collapse inevitably occurs. Therefore no mechanism that causes a load balancer to regulate inputs to servers when the servers are overloaded, has been provided.

If input regulation at edge devices or load balancers and addition of servers that are separately performed as described above can be effectively integrated together to address an increase in traffic, more processing requests can be served by fewer servers. However, there is not a known integrated congestion control method.

An object of the present invention is to maximize the total number of calls that are successfully connected in a given amount of time by performing input regulation and addition of servers in an integrated manner in response to a change and increase in traffic, as compared with separately performing input regulation and addition of servers. Another object is to reduce control cost by using an input regulation value common to servers.

### Solution to Problem

A congestion control method according to a first aspect of the present invention is performed by a controller connected to an edge device and a plurality of servers through a network, and the edge device aggregates service request messages from clients and allocates the service request messages to servers, and the plurality of servers serves service requests from the clients. The congestion control method includes:

a step of acquiring a service request occurrence rate observed by the edge device;

a step of determining a ratio of service request messages to be regulated as a regulation rate on the basis of the occurrence rate and determining the number of servers to be operated; and

a control step of notifying the regulation rate of the edge device and putting a new server into operation or stopping an operating server on the basis of the number of the servers to be operated.

A congestion control system according to a second aspect of the present invention, includes an edge device, a plurality of servers, and a controller, the edge device aggregating service request messages from clients and allocating the service request messages to servers, the plurality of servers serving service requests from the clients. The controller includes: means for acquiring a service request occurrence rate observed by the edge device;

means for determining a ratio of service request messages to be regulated as a regulation rate on the basis of the occurrence rate and determining the number of servers to be active; and

control means for notifying the regulation rate of the edge device and putting a new server into operation or stopping an operating server on the basis of the number of the servers to be active.

A controller according to a third aspect of the present invention is connected to an edge device and a plurality of servers through a network, and the edge device aggregates service request messages from clients and allocates the service request messages to servers, and the plurality of servers serves service requests from the clients. The controller includes:

means for acquiring a service request occurrence rate observed by the edge device;

means for determining a ratio of service request messages to be regulated as a regulation rate on the basis of the occurrence rate and determining the number of servers to be operated; and

control means for notifying the regulation rate of the edge device and putting a new server into operation or stopping an operating server on the basis of the number of the servers to be operated.

A program according to a fourth aspect of the present invention causes a computer provided in a controller connected through a network to an edge device aggregating service request messages from clients and allocating the service request messages to servers and a plurality of servers serving service requests from the clients to execute:

a process of acquiring a service request occurrence rate observed by the edge device;

a process of determining a ratio of service request messages to be regulated as a regulation rate on the basis of the occurrence rate and determining the number of servers to be operated; and

a control process of notifying the regulation rate of the edge device and putting a new server into operation or stopping an operating server on the basis of the number of the servers to be operated.

Note that the program can be provided as a program product recorded on a non-transitory computer-readable storage medium.

### Advantageous Effects of Invention

In a system in which the maximum number of servers that can be added is limited and congestion collapse can occur, the profit that can be obtained by subtracting the cost of server operation from income obtained from the total number of customers that can be successfully served (in a given amount of time) can be increased.

This is because the number of servers is changed as traffic increases so that performance requirements are met while maintaining the regulation rate at 0 as long as addition of the servers is possible and, when the number of servers reaches the upper limit of addition, the regulation rate is changed so that the performance requirements are met.

### BRIEF DESCRIPTION OF DRAWINGS

FIG. 1 is a block diagram illustrating an exemplary configuration of a congestion control system.

FIG. 2 is a block diagram illustrating an exemplary configuration of a controller.

FIG. 3 is a block diagram illustrating an exemplary configuration of an edge device.

FIG. 4A is a diagram illustrating a solution to an optimization problem for profit maximization.

FIG. 4B is a diagram illustrating a solution to an optimization problem for profit maximization.

FIG. 5 is a flowchart illustrating an exemplary operation in congestion control means of the controller.

FIG. 6 is a flowchart illustrating an exemplary operation in load balancing control means of the controller.

FIG. 7 is a graph illustrating exemplary traces of loss rate and the number of servers versus change in the volume of traffic according to an exemplary embodiment.

### DESCRIPTION OF EMBODIMENTS

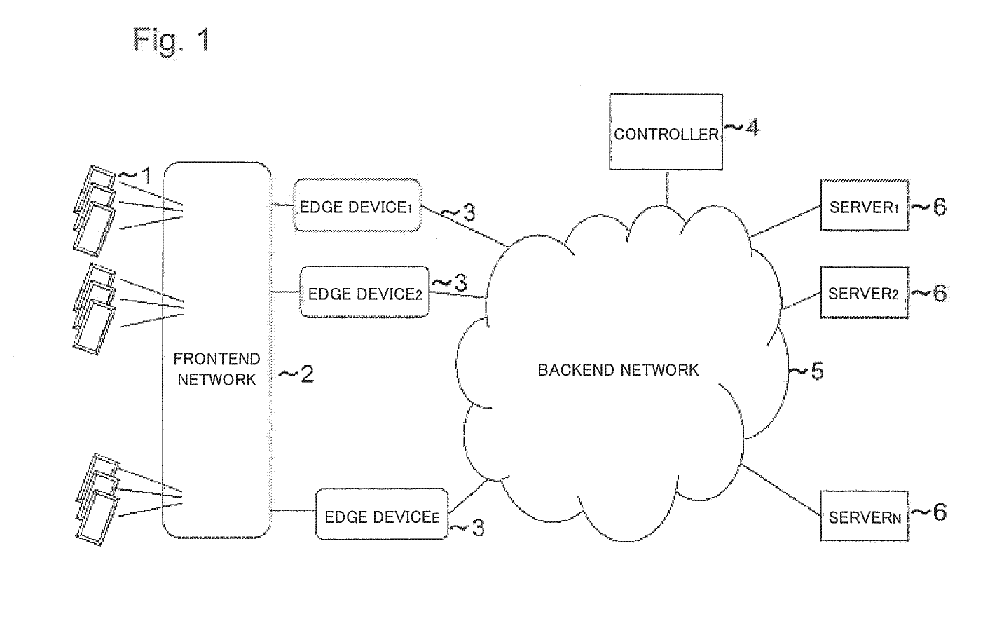

A general configuration of a congestion control system will be described first with reference to FIG. 1. The congestion control system includes clients 1, a frontend network 2, edge devices 3, a controller 4, a backend network 5 and servers 6.

Each of the clients 1 performs service registration with a server 6 allocated to the client 1 by an edge device 3 and sends a service request to the server 6. Prior to the service registration, then edge device 3 is allocated to the client 1 by some other means.

The front-end network 2 is a network that interconnects the clients 1 and the edge devices 3. The edge devices 3 include the function of load balancing. With the function, the edge devices 3 allocate a server 6 to service registration received from a client and subsequently transfers a service request message received from the client to the allocated server 6. The edge devices 3 perform input regulation on service request messages from the clients 1 to reduce the traffic on the servers 6. The controller 4 exchanges messages required for congestion control or load balancing control with the edge devices 3 and the servers 6.

The backend network 5 is a network that interconnects the edge devices 3, the controller 4 and the servers 6. Each of the servers 6 processes service registration received from a client 1 through an edge device 3 and service request messages received subsequently.

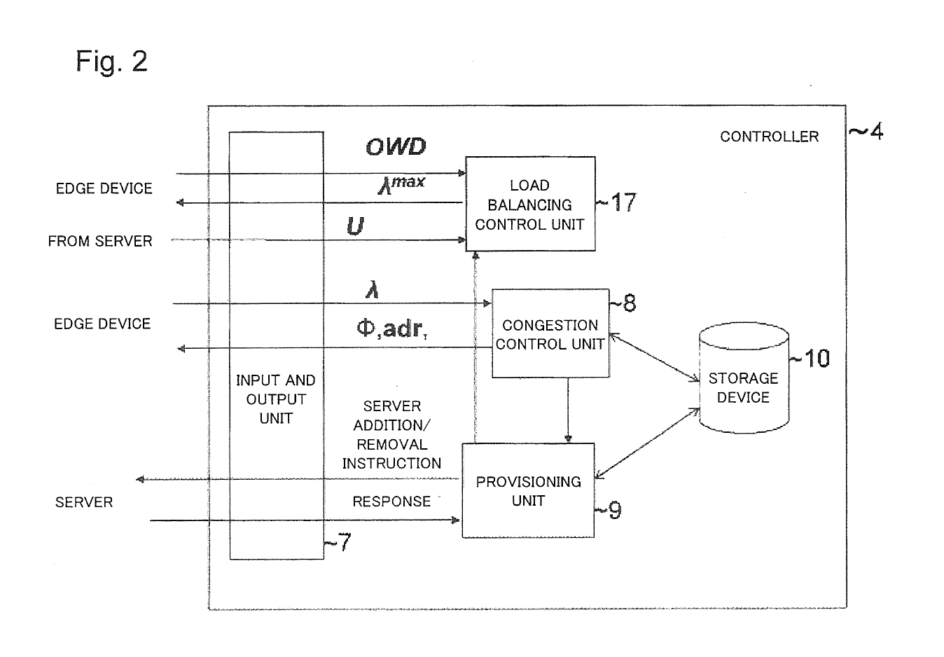

A configuration of the controller 4 will be described next with reference to FIG. 2. The controller 4 includes an input and output means 7, a congestion control means 8, a load balancing control means 17, a provisioning means 9 and a storage device 10.

The congestion control means 8 receives observed performance information about service processing from each of the servers 6 and determines a regulation rate used at the edge devices 3 and the number of servers required on the basis of the performance information. As a result, the congestion control means 8 performs resource management to notify the regulation rate and available servers of each of the edge devices 3.

The load balancing control means 17 receives an observed value of network-level delay in transfer to a server 6 from each edge device 3, receives the number of registered clients 1 from each server 6, determines a maximum-allowable-occurrence-rate for each server 6 on the basis of the observed delay value and the number of registered clients 1, and notifies the maximum-allowable-occurrence-rate of each edge device 3.

The provisioning means 9 sends instruction messages to a server 6 specified by the congestion control means 8 for activation and allocation of the server 6.

The storage device 10 holds the addresses of operating and idle servers 6 and the processing rate (the number of service requests that can be served per unit time) of the servers 6. The storage device 10 further holds the addresses of the edge devices 3, observed performance at servers, input regulation rates, network-level delay between each edge device 3 and each server 6 received from each edge device 3, and the like.

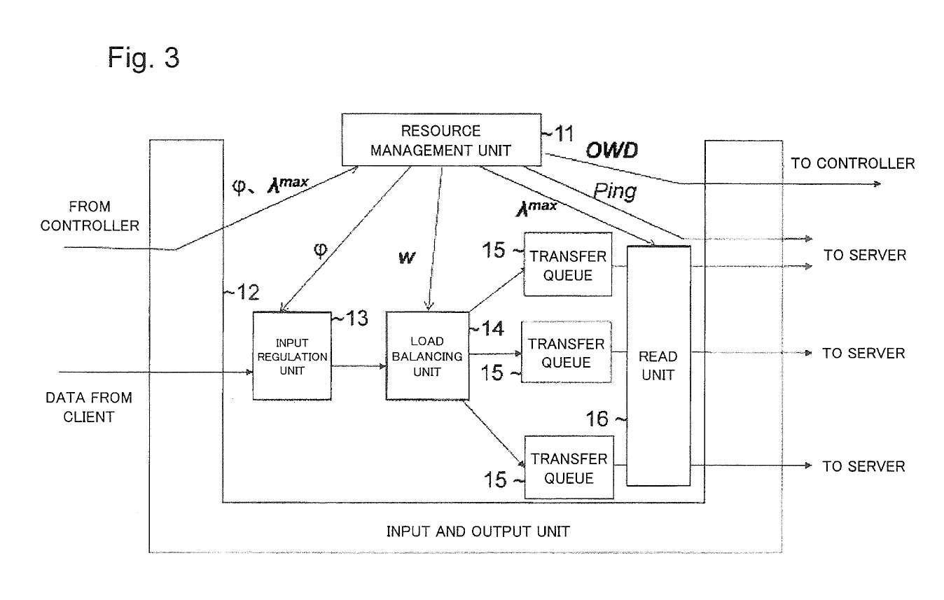

A configuration of an edge device 3 will be described below with reference to FIG. 3. The edge device 3 includes a resource management means 11, an input and output means 12, an input regulation means 13, a load balancing means 14, a plurality of transfer queues 15 and a read means 16.

The resource management means 11 sets a regulation value sent from the controller 4 in the input regulation means 13. The resource management means 11 determines an allocation factor from the maximum-allowable-occurrence-rate at each server 6 sent from the controller 4 and sets the allocation factor in the load balancing means 14. Furthermore, when shaping of each transfer queue 15 by the read means 16, the resource management means 11 sets a shaping rate, which is equal to aforementioned (maximum-allowable-occurrence-rate at servers)(total number of edge devices), in each transfer queue 15.

The following two methods of regulation on inputs at the input regulation means 13 are conceivable. In one method, each time a service request message is received, for example, a random number is assigned on the basis of an input regulation rate φ and, if the random number value is less than φ, the service request message is discarded or a request rejection message is sent back; if the assigned random number value is greater than or equal to φ, the service request message is processed.

The other method is total volume control in which regulation is performed on the basis of a leaky bucket algorithm having two parameters: leak rate r and a bucket size B representing a fluctuation from the leak rate. The leaky bucket algorithm assumes that data is read from a bucket having size B at leak rate r. When the size of an incoming message causes the available capacity of the bucket to be exceeded, the message is discarded.

The load balancing means 14 allocates a server 6 determined on the basis of an allocation factor to a client 1 upon arrival of a service registration request message from the client 1. Messages from the client 1 are transferred to the server 6 that has been once allocated to the client 1 until the client 1 cancels the service registration. The load balancing means 14 places a service request message from each client 1 in a transfer queue 15 associated with the server 6 allocated to the client 1 beforehand.

For example, the load balancing means 14 allocate a service registration request from a client 1 to a server 6 in accordance with the allocation factor. The load balancing means 14 sends messages subsequently transferred from the client 1 to the transfer queue 15 associated with the allocated server 6. The service registration may be an Attach of 3GPP or a user registration of SIP, for example, and once a server 6 is allocated, all messages are sent to the same server 6. The transfer queue 15 is set for each server.

The read means 16 may read a service request message from a transfer queue 15 according to weighted fair queuing on the basis of the allocation factor set by the resource management means 11 or may perform shaping at a rate determined by (maximum-allowable-occurrence-rate)(number of edge devices).

### Operation of Exemplary Embodiments

An operation at the congestion control means 8 of the controller 4 will be described next. An optimum value of the objective function given below is determined.

### [Equation 1]

Objective function maximize a×Σₙ₌₁^{N}(1−φ)λₙ×PG[(1−φ)λₙDₙ]−bN (1)

### [Equation 2]

### Constraint Conditions

Σₙ₋₁^{N}λₙ=λ₀ (2)

λₙ≧0(n=1, . . . , N) (3)

0≦φ≦1 (4)

1≦N≦N^{max} (5)

It is assumed here that the service request message processing capacities of all the servers are equal. Constants will be described first. a is the income obtained when one processing request has been successfully served, b is the cost incurred at one operating server per unit time. Specifically, the cost relates to the power consumption, sever management fee and the like. λ₀ is service request traffic on the whole edge devices. Dₙ is a delay limit that needs to be met at a server n.

PGR, [λ, D] is a function representing service completion probability representing the probability that a service will be completed within a permissible time period D when traffic of the occurrence rate λ, is placed on one server.

Variables will be described next. λₙ is the occurrence rate of service request traffic on the server n out of service request traffic on the whole edge devices, N is the number of servers, φ is an input regulation rate common to the edge devices.

The objective function will be described next. (1−φ)λₙ is traffic placed on the server n after input regulation on each edge device and is referred to as the throughput.

(1−φ)λₙ*PG[(1−φ)λₙ, Dₙ] represents the number of service request messages that can be successfully served per unit time at the server n and is also referred to as the goodput. In the objective function, a*Σₙ=₁^{N}(1−φ)λₙ*PG[(1−φ)λₙ, Dₙ] represents the total income per unit time on the whole servers. On the other hand bN is the cost incurred on the whole servers per unit time and therefore the objective function in Equation (1) can be considered to maximize the total income per unit time.

Since Equation (1) is a nonlinear function for λₙ, Equation (1) is linearly approximated for easy solution of the optimization problem described above. Specifically, since PGR[λ, d] is a decreasing function on λ for a given d, λ*PG[λ, D] has the maximum value for λ. According to NPL 7, the service completion probability in an M/M/1 queue system with parameters, the occurrence rate λ, the processing rate μ, and the maximum allowable delay D is given by PG[λ,D]=1−exp{−(μ−λ)D}. A table indicating values of λ=λ^{max} that yield the maximum value of goodput λ*[1−exp{−(μ−λ)D}] for given D is also given. It can be seen that the value increases with increasing D. Generally, λ^{max} in a given queue system can be obtained by other methods besides the analytical method described above. λ^{max} can be obtained by providing pseudo traffic to a server to obtain a delay distribution for given λ, and adding a graph of goodput for λ to given D to calculate goodput.

If the server accepts service request traffic that has an occurrence rate greater than or equal to λ^{max} , the goodput decreases. Accordingly, λ^{max} is a value indicating that the server should not accept traffic that has the occurrence rate greater than or equal to λ^{max} in order to prevent congestion collapse. Therefore λ^{max} will be also referred to as the maximum-acceptance-occurrence-rate.

In order to linearly approximate Equation (1) on the basis of the discussion given above, PG[λₙ(1−φ), Dₙ]=1 is used to approximate in the range of 0≦λₙ(1−φ)≦λₙ^{max}. From Equations (1) and (2), it follows that

$$\begin{matrix}{Σ}_{n = 1} {}^{N} λ {}_{n} ( 1 - φ ) * PG [ {λ}_{n} ( 1 - φ ) , {D}_{n} ] = ( 1 - φ ) {Σ}_{n = 1} {}_{}^{N}{λ}{}_{n}^{} \\ = ( 1 - φ ) {λ}_{0}\end{matrix}$$

Therefore, the optimization problem given above can be simplified as follows.

### [Equation 3]

Objective function maximize a λ₀(1−φ)−bN (6)

### [Equation 4]

Constraint conditions

Σₙ₌₁^{N}λₙ=λ₀ (2)

0≦λₙ(1=φ)≦λₙ^{max}(n=1, . . . , N) (7)

0≦φ≦1 (4)

1≦N≦N^{max} (5)

λₙ^{max} is the maximum-acceptance-occurrence-rate at the server n. The maximum traffic that can be accepted by the whole servers is defined by Equation (8) given below.

### [Equation 5]

π[N]≡Σₙ₌₁^{N}λₙ^{max} (8)

Then from Equations (2) and (7),

Σₙ₌₁^{N}λₙ(1−φ)=(1−φ)λ₀≦Σₙ₌₁^{N}λₙ^{max}=λ[N]

Therefore, Equation (9) given below can be obtained as a new constraint condition.

### [Equation 6]

φ+λ[N]/λ₀≧1 (9)

Therefore the optimization problem given above can be written as follows:

### [Equation 7]

### Objective Function

maximize a λ₀(1=φ)−bN (6)

### [Equation 8]

Constraint conditions

λ[N]=Σₙ₌₁^{N}λₙ^{max} (8)

φ+λ[N]/λ₀≧1 (9)

1≦φ≦N^{max} (4)

1≦N≦^{max} (5)

Here, if D₁=, . . . , D_{N} and the occurrence rates of service requests allocated to the servers are equal, then k₁^{max}=, . . . , =X_{N}^{max}≡λ^{max} can be obtained. Then Equation (8) can be written as λ[N]=λ^{max}N and Equation (5) can be written as φ+N/(λ₀/φ^{max})≧1. Therefore the optimization problem given above is the maximization problem of a linear function in a linear space made up of the input regulation rate φ and the number N of servers as follows.

### [Equation 9]

Objective function

maximize a λ₀(1−φ)−bN (6)

### [Equation 10]

Constraint conditions

φ+N/(λ₀/λ^{max})≧1 (10)

1≦φ≦N^{max} (4)

1≦N≦^{max} (5)

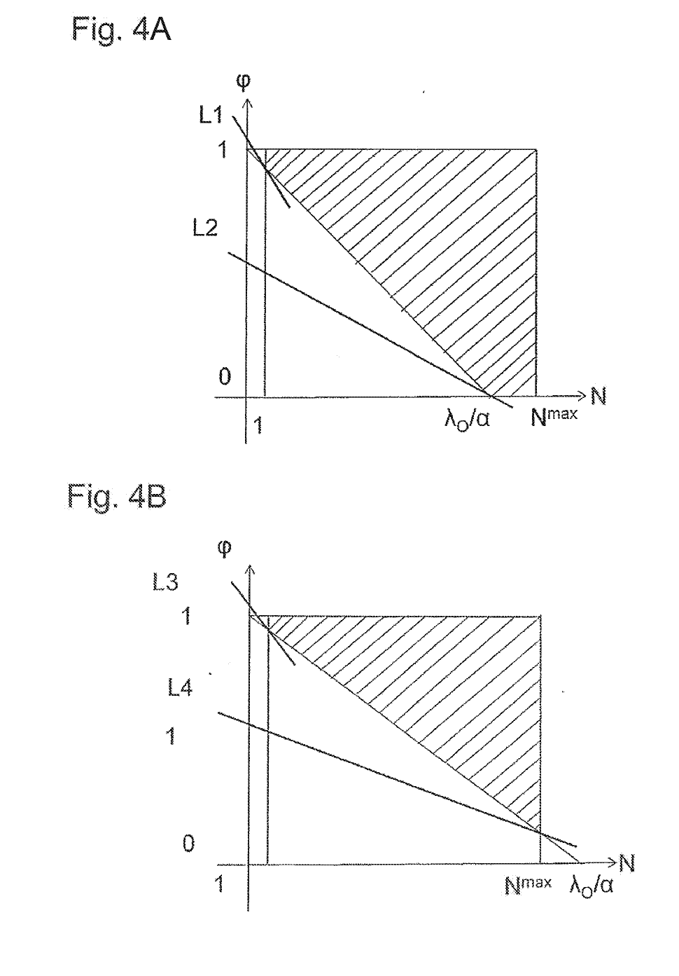

Permitted regions that satisfy the constraint conditions in Equations (10), (4) and (7) in the plane of (N, φ) given above are indicated as shaded areas in FIGS. 4A and 4B.

Here, c is assigned as the value of the objective function (6) and the input regulation rate φ is solved as: φ=−bN/(aλ₀)+(aλ₀−c). The φ segment is aλ₀−c, therefore in order to maximize c, the φ segment of the line given above is minimized in a permitted region.

In doing so, the following two cases need to be considered. One is illustrated in FIG. 4A, i.e. if λ₀/λ^{max}<N^{max}, Equation (11) given below is established,

### [Equation 11]

N=ceil (λ₀/λ^{max})

φ=0 (11)

where ceil represents the ceiling function.

Specifically, if traffic on an edge devices 3 is less than the maximum capacity on the server 6 side, then the regulation rate φ is set to 0 and a minimum number N of servers necessary to accept the traffic on the edge device 3 are provided.

On the other hand, in the case where the permitted region is as illustrated in FIG. 4B, i.e. if λ₀/λ^{max}≧N^{max}, Equation (12) given below is established.

### [Equation 12]

N=^{max},

φ=1−λ^{max}/λ₀ (12)

Specifically, if traffic on the edge devices 3 exceeds the maximum capacity on the server 6 side, the maximum number N^{max} of available servers 6 are put into operation and input of traffic that exceeds the capacity provided by the maximum number of servers 6 needs to be regulated.

Advantageous effects of this exemplary embodiment will be described below. From Equation (12), the input regulation rate φ indicates the ratio of traffic regulated with respect to a given number of servers. The greater N^{max}, the smaller the ratio is. Accordingly, if the processing capacity can be increased as compared with a system that has a fixed processing capacity, the exemplary embodiment has the advantageous effect that the volume of traffic that is prevented from being input can be decreased or the volume of traffic that is allowed to flow can be increased.

Furthermore, the values of N and ₄ described above are substituted into Equation (4) and it is approximate that N can take continuous numbers. Then, when λ₀/λ^{max}<N^{max}, the optimum value of the objective function is a*λ₀−bλ₀/λ^{max}=(a−b/λ^{max})λ₀ and increases with λ; when λ₀/λ^{max}≧N^{max}, the optimum value is constant as (a*λ^{max}−b)N^{max}.

The following relations of the parameters a and b can be derived from the maximum value of income described above. In order for the income to take a positive value for a given λ₀, the condition aλ^{max}>b needs to be met. This means that the maximum income from one server provided needs to exceed the cost of the provision of the server. This corresponds to lines L2 and L4 in FIGS. 4A and 4B, respectively.

On the other hand, if a*λ^{max}≦b, increasing N^{max} causes to decrease the income. Therefore, in order to maximize the income, N^{max} need to be equal to 1 and there is no point in adding servers. This corresponds to lines L1 and L3 in FIGS. 4A and 4B, respectively.

The optimization problem is set as described above and congestion control is performed on the basis of the solution to the optimization problem. In this case, only the number N of servers and φ which is the input regulation value common to the edge devices, need to be determined from Equation (11) or (12) for λ₀=Σₑ₋₁^{E}λₑ which can be obtained from the sum of occurrence rates X, obtained by observation at the edge devices. Accordingly, unlike in NPL 2, the need for performing control for each server, such as placing input regulation on each individual server, after detecting congestion on each server is eliminated.

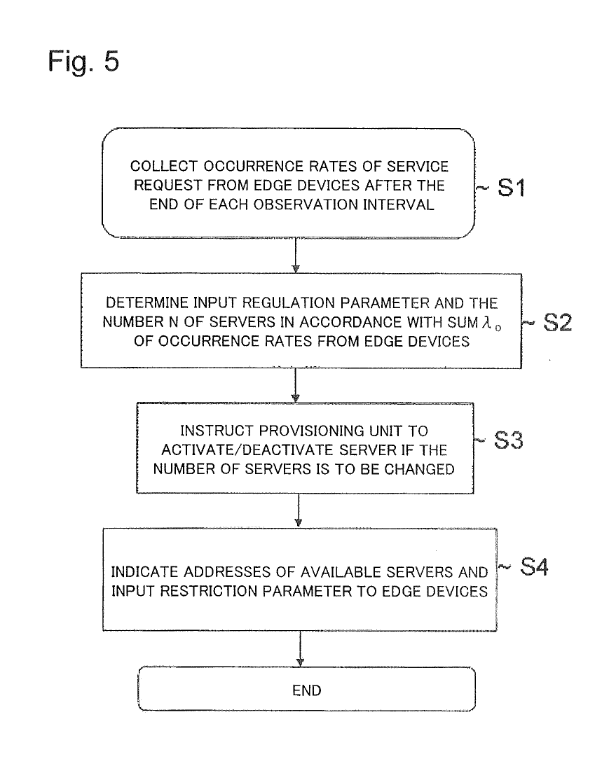

An operation by the congestion control means 8 of the controller 4 based on the foregoing will be described below in detail with reference to a flowchart in FIG. 5. It is assumed here that the maximum occurrence rate of service requests that can be accepted by each server has been given beforehand.

The congestion control means 8 collects observed values of occurrence rates from the edge devices 3 at the end of each control interval (step S1). The congestion control means 8 then determines the number N of servers and an input regulation parameter (an input regulation rate (discard rate) φ or a leak rate m) from the sum of occurrence rates received from the servers 6 and the number of current operating edge devices 3 in accordance with Equations (11) and (12) and stores the number N of servers and the parameter in the storage device (step S2). Furthermore, the congestion control means 8 instructs the provisioning means 9 to put the server into operation or stop the service if a new server is to be added or the operating server is to be removed, and then updates the addresses of operating servers 6 on the storage device 10 (step S3). The congestion control means 8 then reads the input regulation parameter and the addresses of available servers from the storage device and provides them to the edge devices (step S4).

Note that the server 6 that has received an instruction to stop itself from the provisioning means 9 at step S3 needs to transfer users registered with the server 6 to another server 6 before stopping itself actually. For that purpose, the congestion control means 8 directly or indirectly instructs the server 6 that has received the stop instruction to reregister the clients 1 registered with the server 6 with another server 6. When the reregistration of all clients 1 with the different server 6 is completed, the server 6 stops itself.

An operation relating to load balancing at the edge devices 3 will be described next. Prior to the description, quantitative modelling will be described. It is assumed here that services at a server n can be completed if the total delay including network delay from an edge devices 3 to the server 6 is less than or equal to d.

Here, processing is considered to be completed when the total time that is equal to network-level round-trip time RTT_{e,n} from an edge device e (=1, . . . , E) to a server n plus processing time tₙ^{srv} at the server 6, i.e. t_{e,n}^{total}=tₙ^{srv}+RTT_{e,n}, is less than or equal to D, which is common to given pairs of edge device 3 and server 6. For processing at a server n to be considered completed, the condition tₙ^{srv}≦D−RTT_{e,n} for all e=1, . . . , E, i.e. tₙ^{srv}≦D−maxₑ₌₁, . . . _{E}RTT_{e,n} for all edge devices 3 needs to be met. Since the service completion probability P at the server n can be written as PG[λₙ,D−maxₑ₌₁, . . . , _{E}RTT_{e,n}] by using the function representing goodput, the goodput at the server n is λₙ*PG[λₙ, D−maxₑ₌₁, . . . , _{E}RTT_{e,n}]. As described previously, in order to maximize the goodput GP[λ,τ], the edge device 3 applies pseudo traffic of an occurrence rate λ to the server to measure delay beforehand and calculates a delay distribution for λ to obtain λ=λ^{max} for each τ from the delay distribution. The results may be held in tabular form by the edge device 3, for example.

In order to allow the controller 4 to retrieve λₙ=λₙ^{max} that maximizes the goodput described above from the table, τₙ needs to be calculated.

For that purpose, RTT measured between each edge device 3 and each server 6 is collected from the edge devices. Then τₙ=D−max_{c=1}, . . . , _{E}RTT_{e,n} (n=1, . . . , N) and λₙ^{max} (n=1, . . . , N) obtained from τₙ for all of the servers 6 are notified of the edge devices 3, thereby allowing each edge device 3 to calculate the allocation factor to the servers n as follows.

### [Equation 13]

wₙ=λₙ^{max}/Σₙ₌₁^{N}λₙ^{max}(n=1, . . . , N) (13)

Since the total number of the edge devices is E, the peak rate for service request traffic from a server n having the maximum-acceptance-occurrence-rate kₙ^{max} is shaped with the value of mₙ=kₙ^{max}/E (n=1, . . . , N) at each edge device 3. Then, since traffic of at most λₙ^{max} is placed on the server n from all edge devices, congestion collapse at the server n can be prevented.

Note that immediately after addition of a new server 6, the level of load relating to serving connection requests needs to be quickly increased to the level equivalent to the levels of the other servers 6. Therefore, in order to concentrate registration of new clients on the server 6, an allocation factor for the server 6 is applied in a way different from the normal way, as follows.

The controller 4 adds a new server 6 according to the congestion control method described with reference to FIG. 5. When the controller 4 receives a response indicating completion of the addition from the provisioning means 9, the controller 4 sets an addition mode. The controller 4 then sets a maximum-acceptance-occurrence-rate of 100 for the new server 6 and sets a maximum-acceptance-occurrence-rate of 0 for the other servers 6, for example, and notifies the set maximum-acceptance-occurrence-rates of the edge devices 3. Alternatively, the controller 4 directly or indirectly instructs the other servers 6 to cause the servers 6 to reregister clients service-registered with the server 6 with the new server 6. The concentration of allocation of clients 1 on the new server 6 is continued until the number of clients 1 registered with the new server 6 exceeds the average number of clients registered with the whole servers, for example. In order to calculate the average described above, the controller 4 periodically accesses the servers 6 to receive information about the numbers of clients registered with the servers 6.

By taking into account the information described above, the resource management means 11 of each edge device 3 performs the following operation. The edge device 3 sends an IP ping or the like to the servers 6 to measure the network-level round-trip time RTT. When RTT radically changes, the edge device 3 sends a vector of the worst value of RTT to the servers 6 to the controller 4.

When the edge device 3 receives the maximum-acceptance-occurrence-rate λ^{max}=(λ₁^{max}, . . . , λ_{N}^{max}) of each of the servers 6 from the controller 4, the edge device 3 calculates an allocation factor from the maximum-acceptance-occurrence-rate in accordance with Equation (1), sets the maximum-acceptance-occurrence-rate in the load balancing means 14 and directly sets the maximum-acceptance-occurrence-rate as the shaping rate of the transfer queues 15.

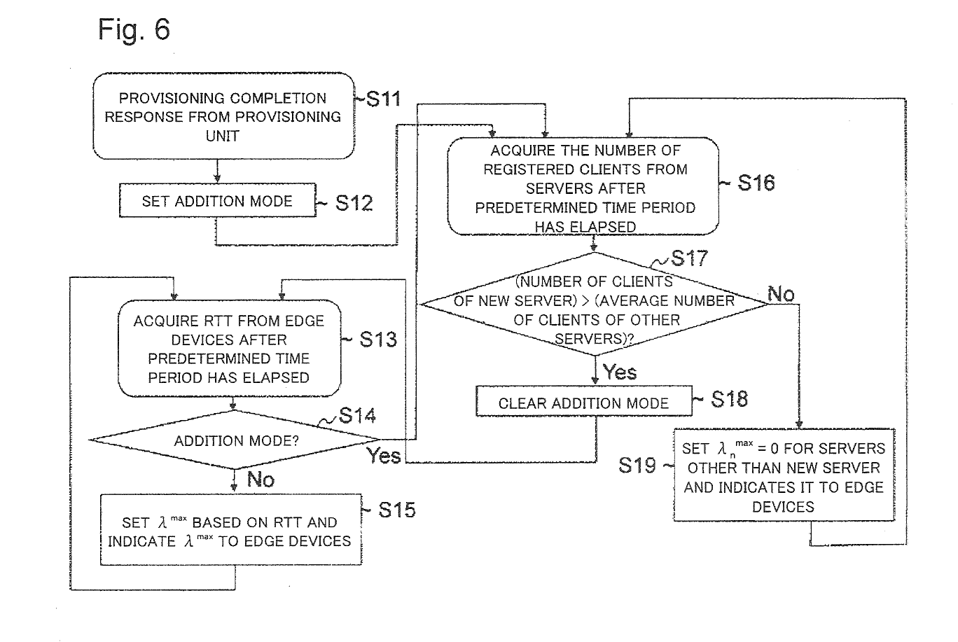

An operation of the load balancing control means 17 of the controller 4 will be described with reference to FIG. 6. When a response indicating the completion of server provisioning is output from the provisioning means 9 (step S11), the load balancing control means 17 sets an addition mode (step S12) and proceeds to step S16.

After a predetermined time period has elapsed, the load balancing control means 17 receives RTT from each edge device 3 (step S13) and determines whether or not the addition mode is entered (step S14). If the addition mode is entered (Yes at step S14), the load balancing control means 17 proceeds to step 16. If the addition mode is not entered at step 14 (No at step S14), the load balancing control means 17 calculates λ^{max} based on RTT for each available server 6, notifies kmax of the edge devices 3 along with the addresses of the available servers 6 (step S15), and returns to step S13.

At step S16, the load balancing control means 17 acquires the number of registered clients from each server after a predetermined time period has elapsed. The load balancing control mean 17 then determines whether or not the number of clients of a new server exceeds the average number of clients of the other servers (step S17). When the number of clients of the new server exceeds the average number of clients (Yes at step S17), the load balancing control means 17 clears the addition mode and sets the maximum-acceptance-occurrence-rate that maximizes the goodput described above (step S18), and proceeds to step S13. On the other hand, if the number of clients of the new server does not exceed the average number of clients at step S17 (No at step S17), the load balancing control means 17 sets λₙ^{max}=0 for the maximum-acceptance-occurrence-rate for the existing servers other than the newly added server, sets λₙ^{max}=100 for the newly added server (step S19), and proceeds to step S16.

With the operation described above, once a server is added, new clients are registered exclusively with the newly added server until the number of clients of the new server increases from 0 to a level equivalent to the numbers of clients of the other operating servers. Accordingly, the load level of the newly added server can be more quickly made equal to the load levels of the other servers.

Furthermore, when the numbers of clients registered with the servers are leveled out, registration of new clients 1 is allocated so that the total delay between each edge device 3 and each server 6 meets permissible time.

A practical example based on this exemplary embodiment will be described next.

FIG. 6 illustrates traces of the input regulation rate φ and the number N of servers, which are control variables, as λ₀ changes with time. It is assumed that the processing rates of all of the servers 6 are equal, μ, and the network delays between the edge devices 3 and the servers 6 are also equal. As λ₀ increases, the number N of servers is increased while maintaining the input regulation rate φ=0. When λ is increasing after N reaches N^{max}, φ is increased as λ₀ increases while maintaining N=N^{max}.

On the other hand, when X, decreases after this state, the input regulation rate φ is decreased. When λ₀ urther decreases after the input regulation rate φ has reached 0, the number N of servers is decreased while maintaining the input regulation rate φ=0 as illustrated.

The present invention is applicable to EPC of 3GPP by treating eNodeB and MME as an edge device and a server, respectively. The present invention is also applicable to VOIP in IMS which uses SIP, by treating I-CSCF and S-CSCF as an edge device and a server, respectively.

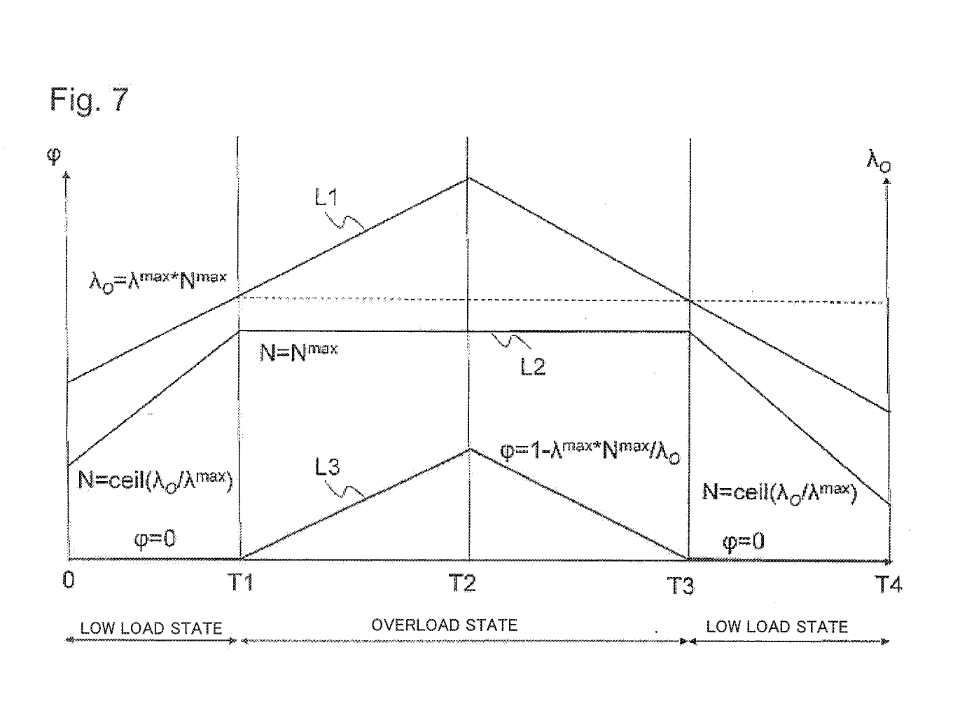

Traces of values of the input regulation rate φ and the number N of servers, which are control variables, as traffic λ₀ on the whole of a plurality of edge devices 3 changes with time will be described next with reference to FIG. 7. It is assumed that the processing rates of all of the servers are equal, μ, and the network delays between the edge devices 3 and the servers 6 are also equal.

The horizontal axis of FIG. 7 represents time passage. Specifically, the time passing from left to right along the horizontal axis is represented. The left-hand vertical axis represents the value of the input regulation rate φ. The right-hand vertical axis represents value of λ₀. While there is not an axis that represents the number N of servers in FIG. 7, changes in the graph represent changes in the number of servers.

L1 in FIG. 7 indicates that λ₀ is increasing in the period from time 0 to time T2 and is decreasing in the period from time T2 to time T4. The state in the period from time 0 to time T1 in which λ₀ is increasing is a low load state. The state in the period from time T1 to time T2 in which λ₀ is increasing and the state in the period from time T2 to time T3 in which λ₀ is decreasing are overload states. The state in the period from time T3 to time T4 in which λ₀ is decreasing is a low load state.

L2 in FIG. 7 represents changes in the number N of servers. The number N of operating servers is increased as λ₀ increases in the period from time 0 to time T1. After the number N of operating servers reached N^{max} at time T2, the number N of servers is maintained at N^{max} in the overload state until time T3. In the period from time T3 to time T4, the number N of operating servers is decreased as λ₀ decreases.

L3 in FIG. 7 represents the value of the input regulation rate φ. The input regulation rate φis set at 0 in the period from time 0 to time T1. Specifically, the input regulation rate φ is set at 0 in the period from time 0 to time T1 and the number of operating servers is increased to accommodate the increase in traffic λ₀. After the number N of servers reached N^{max} at time T1, the input regulation rate φ is increased with increasing traffic λ₀ to adjust the volume of traffic sent to each server 6. In the period from time T2 to time T3, the input regulation rate φ is decreased as traffic λ₀ decreases. In the period from time T3 to time T4, the input regulation rate φ is set at 0 and the number N of servers is decreased to respond to decreasing traffic λ₀.

In this way, the congestion control according to the present invention does not regulate input of traffic in a period during which the number of operating servers can be increased with increasing traffic and, when the number of operating servers reaches the upper limit, regulates input of traffic. This control can increase the number of service requests that are served.

The present invention can be implemented in the following modes.

### [Mode 1]

Mode 1 is the same as the congestion control method according to the first aspect described above.

### [Mode 2]

In the control step, when the number of operating servers is less than the maximum allowable number, a server may be put into operation or stopped in accordance with a change in the occurrence rate without performing an input regulation based on the regulation rate described above and, when the number of operating servers reaches the maximum allowable number, the input regulation based on the regulation rate may be performed in accordance with changes in the occurrence rate.

### [Mode 3]

The edge device may be eNodeB conforming to Evolved Packet System (EPS) of 3GPP and each of the plurality of servers may be MME (Mobility Management Entity) conforming to the EPS.

### [Mode 4]

The edge device and the plurality of servers may be CSCF (Call Session Control Function) conforming to IMS (IP Multimedia Subsystem) of 3GPP.

### [Mode 5]

Mode 5 is the same as the congestion control system according to the second aspect described above.

### [Mode 6]

When the number of operating servers is less than the maximum allowable number, the control means may put into operation or stop a server in accordance with a change in the occurrence rate without performing input regulation based on the regulation rate described above and, when the number of operating servers reaches the maximum allowable number, may perform the input regulation based on the regulation rate in accordance with a change in the occurrence rate.

### [Mode 7]

The edge device may be eNodeB conforming to Evolved Packet System (EPS) of 3GPP and each of the plurality of servers may be MME (Mobility Management Entity) conforming to the EPS.

### [Mode 8]

The edge device and the plurality of servers may be CSCF (Call Session Control Function) conforming to IMS (IP Multimedia Subsystem) of 3GPP.

### [Mode 9]

Mode 9 is the same as the control device according to the third aspect described above.

### [Mode 10]

When the number of operating servers is less than the maximum allowable number, the control means may put into operation or stop a server in accordance with a change in the occurrence rate without performing an input regulation based on the regulation rate described above and, when the number of operating servers reaches the maximum allowable number, may perform the input regulation based on the regulation rate in accordance with a change in the occurrence rate.

### [Mode 11]

Mode 11 is the same as the program according to the fourth aspect described above.

### [Mode 12]

In the control step, when the number of operating servers is less than the maximum allowable number, a server may be put into operation or stopped in accordance with a change in the occurrence rate without performing an input regulation based on the regulation rate described above and, when the number of operating servers reaches the maximum allowable number, the input regulation based on the regulation rate may be performed in accordance with changes in the occurrence rate.

According to the present invention, an inventive method and system described in the following supplementary notes are provided.

### [Supplementary Note 1]

A congestion control method used in a congestion control system in which a plurality of edge devices, a plurality of servers and at least one controller are interconnected through a network, the plurality of edge devices aggregating service request messages from a plurality of clients and allocating the service request messages to servers, the plurality of servers serving service requests from clients,

wherein the controller acquires information about an observed service request occurrence rate from the edge devices, determines at least a rate to be regulated a service request message and the total number of servers to be operated on the basis of the information, provides information about the rate to be regulated to the edge devices on the basis of the rate and the number of the servers to be operated, and puts into operation a new server or stops a service of an operating server.

### [Supplementary Note 2]

The congestion control method according to Supplementary Note 1, wherein when the number of operating servers is less than a maximum allowable number, an input regulation is not performed and a server is put into operation or stopped in accordance with a change in the occurrence rate and, when the number of operating servers reaches the maximum allowable number, the input regulation is performed in accordance with a change in the occurrence rate.

### [Supplementary Note 3]

The congestion control method according to Supplementary Note 1 or 2, wherein each of the edge devices is eNodeB conforming to Evolved Packet System (EPS) of 3GPP and each of the servers is MME conforming to the EPS.

### [Supplementary Note 4]

The congestion control method according to Supplementary Note 1 or 2, wherein each of the edge devices and each of the servers are CSCF conforming to IMS of 3GPP.

### [Supplementary Note 5]

A congestion control system in which a plurality of edge devices, a plurality of servers and at least one controller are interconnected through a network, the plurality of edge devices aggregating service request messages from a plurality of clients and allocating the service request messages to servers, the plurality of servers serving service requests from clients,

wherein the controller acquires information about an observed service request occurrence rate from the edge devices, determines at least a rate to be regulated of a service request message and the total number of servers to be operated on the basis of the information, provides information about the rate to be regulated to the edge devices on the basis of the rate and the number of the servers to be operated, and puts a new server into operation or stops a service of an operating server.

### [Supplementary Note 6]

The congestion control system according to Supplementary Note 5, wherein when the number of operating servers is less than a maximum allowable number, a server is put into operation or stopped in accordance with a change in the occurrence rate while maintaining the regulation rate at 0 and, when the number of operating servers reaches the maximum allowable number, the regulation rate is changed in accordance with a change in the occurrence rate.

### [Supplementary Note 7]

The congestion control system according to Supplementary Note 5 or 6, wherein each of the edge devices is eNodeB conforming to Evolved Packet System (EPS) of 3GPP and each of the servers is MME conforming to the EPS.

### [Supplementary Note 8]

The congestion control system according to Supplementary Note 5 or 6, wherein each of the edge devices and each of the servers are CSCF conforming to IMS of 3GPP.

Note that the contents disclosed in the non patent literatures cited above are incorporated herein by reference. Modifications and adaptations of the exemplary embodiments can be made within the scope of the entire disclosure of the present invention (including the claims and the drawings) on the basis of the fundamental technical idea of the present invention. Furthermore, various combinations or selections of the disclosed elements (including the elements in the claims, the elements in the exemplary embodiments and the elements in the drawings) are possible within the scope of the claims of the present invention. In other words, it would be understood that the present invention encompasses various variations and modifications that can be made by those skilled in the art in accordance with the entire disclosure, including the claims and drawings, and the technical idea. In particular, any values or subranges included in the numerical value ranges disclosed herein that are not explicitly disclosed should be considered to be specifically disclosed.

### REFERENCE SIGNS LIST

1 . . . Client
2 . . . Frontend network
3 . . . Edge device
4 . . . Controller
5 . . . Backend network
6 . . . Server
7, 12 . . . Input and output means
8 . . . Congestion control means
9 . . . Provisioning means
10 . . . Storage device
11 . . . Resource management means
13 . . . Input regulation means
14 . . . Load balancing means
15 . . . Transfer queue
16 . . . Read means
17 . . . Load balancing control means
N . . . The number of servers
φ . . . Input regulation rate

1. A congestion control method performed by a controller connected to an edge device and a plurality of servers through a network, the edge device aggregating service request messages from clients and allocating the service request messages to servers, the plurality of servers serving service requests from the clients, the congestion control method comprising:
a step of acquiring a service request occurrence rate observed by the edge device;
a step of ,on the basis of the occurrence rate, determining a ratio of service request messages to be regulated as a regulation rate and determining the number of servers to be operated; and
a control step of notifying the regulation rate of the edge device and putting a new server into operation or stopping an operating server on the basis of the number of the servers to be operated.

2. The congestion control method according to claim 1,
wherein in the control step, when the number of operating servers is less than a maximum allowable number, putting into operation or stopping the server on the basis of a change in the occurrence rate without performing an input regulation based on the regulation rate, and when the number of operating servers reaches the maximum allowable number, the input regulation based on the regulation rate is performed in accordance with a change in the occurrence rate.

3. The congestion control method according to claim 1,
wherein the edge device comprises eNodeB conforming to Evolved Packet System (EPS) of 3GPP; and
each of the plurality of server comprises Mobility Management Entity (MME) conforming to the Evolved Packet System.

4. The congestion control method according to claim 1,
wherein the edge device and each of the plurality of servers comprises Call Session Control Function conforming to IMS (IP Multimedia Subsystem) of 3GPP.

5. A congestion control system comprising an edge device, a plurality of servers, and a controller, the edge device aggregating service request messages from clients and allocating the service request messages to servers, the plurality of servers serving service requests from the clients,
wherein the controller comprises:
a unit configured to acquire a service request occurrence rate observed by the edge device;
a unit configured to determine a ratio of service request messages to be regulated as a regulation rate on the basis of the occurrence rate and determining the number of servers to be operated; and
a control unit configured to notify the regulation rate of the edge device and putting a new server into operation or stopping an operating server on the basis of the number of the servers to be operated.

6. The congestion control system according to claim 5,
wherein when the number of operating servers is less than a maximum allowable number, the control unit puts into operation or stops a server on the basis of a change in the occurrence rate without performing an input regulation based on the regulation rate, and when the number of operating servers reaches the maximum allowable number, the control unit performs the input regulation based on the regulation rate in accordance with a change in the occurrence rate.

7. The congestion control system according to claim 5,
wherein the edge device comprises eNodeB conforming to Evolved Packet System(EPS) of 3GPP; and
each of the plurality of server comprises MME (Mobility Management Entity) conforming to the Evolved Packet System.

8. The congestion control system according to claim 5,
wherein the edge device and each of the plurality of servers comprises CSCF(Call Session Control Function) conforming to IMS(IP Multimedia Subsystem) of 3GPP.

9. A controller connected to an edge device and a plurality of servers through a network, the edge device aggregating service request messages from clients and allocating the service request messages to servers, the plurality of servers serving service requests from the clients, the controller comprising:
a unit configured to acquire a service request occurrence rate observed by the edge device;
a unit configured to determine a ratio of service request messages to be regulated as a regulation rate on the basis of the occurrence rate and determining the number of servers to be operated; and
a control unit configured to notify the regulation rate of the edge device and putting a new server into operation or stopping an operating server on the basis of the number of the servers to be operated.

10. The controller according to claim 9,
wherein when the number of operating servers is less than a maximum allowable number, the control unit puts into operation or stops a server on the basis of a change in the occurrence rate without performing an input regulation based on the regulation rate, and when the number of operating servers reaches the maximum allowable number, the control unit performs the input regulation based on the regulation rate in accordance with a change in the occurrence rate.

11. A non-transitory computer-readable storage medium storing a program causing a computer provided in a controller connected through a network to an edge device aggregating service request messages from clients and allocating the service request messages to servers and a plurality of servers serving service requests from the clients to execute:
a process of acquiring a service request occurrence rate observed by the edge device;
a process of determining a ratio of service request messages to be regulated as a regulation rate on the basis of the occurrence rate and determining the number of servers to be operated; and
a control process of notifying the regulation rate of the edge device and putting into operation a new server or stopping an operating server on the basis of the number of the servers to be operated.

12. The storage medium according to claim 11, wherein storing a program for causing a computer to execute,
in the control process, when the number of operating servers is less than a maximum allowable number, a server is put into operation or stopped on the basis of a change in the occurrence rate without performing an input regulation based on the regulation rate, and when the number of operating servers reaches the maximum allowable number, the input regulation based on the regulation rate is performed in accordance with a change in the occurrence rate.

13. A congestion control system comprising an edge device, a plurality of servers, and a controller, the edge device aggregating service request messages from clients and allocating the service request messages to servers, the plurality of servers serving service requests from the clients,
wherein the controller comprises:
means for acquiring a service request occurrence rate observed by the edge device;
means for determining a ratio of service request messages to be regulated as a regulation rate on the basis of the occurrence rate and determining the number of servers to be operated; and
control means for notifying the regulation rate of the edge device and putting a new server into operation or stopping an operating server on the basis of the number of the servers to be operated.
